(19) United States
(12) Patent Application Publication
(10) Pub. No.: US 2015/0284482 A1
(43) Pub. Date: Oct. 8, 2015

(54) PREPARING AQUEOUS POLYMER DISPERSIONS WITH PROTECTIVE COLLOIDS IN A MONOMER FEED PROCESS

(71) Applicant: BASF SE, Ludwigshafen (DE)

(72) Inventors: Oral Aydin, Mannheim (DE); Andrea Schindler, Heidelberg (DE); Florian Buesch, Neustadt (DE); Juergen Siroky, Mannheim (DE); Matthias Gerst, Pudong New District Shanghai (CN)

(73) Assignee: BASF SE, Ludwigshafen (DE)

(21) Appl. No.: 14/432,666

(22) PCT Filed: Sep. 27, 2013
(86) PCT No.: PCT/EP2013/070178

§ 371 Date: Mar. 31, 2015

Related U.S. Application Data
(60) Provisional application No. 61/710,015, filed on Oct. 5, 2012.

(30) Foreign Application Priority Data
Oct. 5, 2012 (EP) 12187454.9

(51) Int. Cl. C08F 2/22

(52) U.S. Cl. CPC C08F 2/22

(57) ABSTRACT

A description is given of a process for preparing an aqueous polymer dispersion having a high solids content of greater than 60 wt. %. In this process, a dispersed polymer is prepared by radical emulsion polymerization in the presence of a polymeric protective colloid. The polymer is formed to an extent of at least 80 wt. % of (meth)acrylate ester monomers and the polymeric protective colloid is formed from acid monomers and to an extent of at least 10 wt. % from (meth)acrylate ester monomers, and the sum of (meth)acrylate ester monomers and acid monomers in the protective colloid is at least 80 wt. %. The emulsion polymerization takes place in a monomer feed process, the initial rate of the monomer feed being lower than the final rate.

One of the possible uses of the aqueous polymer dispersions is as adhesives.

The invention relates to a process for preparing an aqueous polymer dispersion based on (meth)acrylate ester monomers, with high solids content, the preparation taking place in the presence of particular protective colloids and preferably in emulsifier-free form. One of the possible uses of the aqueous polymer dispersions is as adhesives.

There is a great demand for adhesives based on aqueous dispersions with good performance properties. Water-based adhesive systems have the advantage of a reduction in organic solvent emissions. Particular importance is possessed by acrylate ester polymer dispersions, also known as acrylate latex. Acrylate ester-based adhesives are described for example in WO 98/23656 and in WO 00/50480. However, a high water fraction entails a frequently unwanted cost and complexity for the drying and filming of the aqueous systems. The aim is therefore for dispersions with as high as possible a solids content and hence as low as possible a water content.

Emulsion polymers are frequently prepared by emulsion polymerization in the presence of nonpolymeric emulsifiers of low molecular mass. The emulsifiers that are therefore present, as a consequence of the preparation process, in the dispersion, however, may have the undesired effect of negatively impacting the performance properties. The aim is therefore for polymer dispersions which have a very low emulsifier content or are emulsifier-free. It is also known in principle to carry out emulsion polymerization substantially without emulsifiers, if protective colloids are used in place of the emulsifiers. Typical protective colloids are polymers containing acid groups, which become water-soluble at elevated pH when the acid groups are neutralized. Polymer dispersions containing protective colloids and having high solids contents of more than 55 wt. % or more than 60 wt. %, for example, often have the disadvantage of poor rheological properties and are too highly viscous or no longer sufficiently fluid for coatings on substrates.

The object was to provide aqueous polymer dispersions having a high solids content for which it is possible very largely to do without the use of emulsifiers to stabilize the dispersions, and where the dispersions, in spite of the high solids content, have good rheological properties, more particularly a very good fluidity.

It has been found that the object can be achieved by the preparation process elucidated in more detail below and by the polymer dispersions obtainable by said process. The invention provides a process for preparing an aqueous polymer dispersion,
where the polymer dispersion has a solids content of greater than 60 wt. %, as for example at least 61 wt. %, at least 63 wt. %, or at least 65 wt. %, and
a polymer A in dispersion in water is prepared in an aqueous medium by radical emulsion polymerization in the presence of a polymeric protective colloid B, and
where the polymer A is formed to an extent of at least 80 wt. % of (meth)acrylate ester monomers,
where the polymeric protective colloid B is formed from acid monomers and to an extent of at least 10 wt. % from (meth)acrylate ester monomers and the total of (meth)acrylate ester monomers and acid monomers in the protective colloid is at least 80 wt. %, or at least 90 wt. %, as for example 80 to 100 wt. % or 90 to 100 wt. %;
where at least 80 wt. %, preferably 80 to 100 wt. % of the total amount of the protective colloid is run in during the emulsion polymerization in a feed process;
where the emulsion polymerization takes place in the monomer feed process with a changing feed rate;
where the initial rate of the monomer feed is lower than the final feed rate.

The invention also provides aqueous polymer dispersions prepared by the process of the invention, and the use of the aqueous polymer dispersions of the invention for producing adhesives.

The polymer dispersions prepared in accordance with the invention are obtainable by radical emulsion polymerization of ethylenically unsaturated compounds (monomers).

This polymerization takes place preferably in emulsifier-free form or with low emulsifier content, in the sense that no emulsifier is added to stabilize the polymer dispersion of the invention. Emulsifiers are nonpolymeric, amphiphilic, surface-active substances that are added to the polymerization mixture. Small amounts of emulsifiers, arising for example from the use of emulsifier-stabilized polymer seed, are harmless. It is preferred for in total less than 1 or less than 0.5 wt. %, more particularly less than 0.3 wt. % or less than 0.2 wt. %, of emulsifier, based on solids content of the polymer dispersion, or for no emulsifier, to be used.

The protective colloid B is formed from ingredients which include acid monomers. Acid monomers are ethylenically unsaturated, radically polymerizable compounds which have at least one acid group. The acid monomers are used in an amount of preferably 10 to 50 wt. %, more particularly of 15 to 45 wt. %, based on the total amount of monomers from which the protective colloid is formed. The acid monomers are copolymerized with monomers without acid groups, more particularly non-ionic monomers. The weight ratio of monomers having acid groups to monomers without acid groups is preferably in the range from 10:90 to 50:50, more particularly from 15:88 to 45:55.

Acid monomers are, for example, ethylenically unsaturated carboxylic acids, ethylenically unsaturated sulfonic acids, and vinylphosphonic acid. Ethylenically unsaturated carboxylic acids used are preferably alpha,beta-monoethylenically unsaturated monocarboxylic and dicarboxylic acids having preferably 3 to 6 C atoms in the molecule. Examples thereof are acrylic acid, methacrylic acid, itaconic acid, maleic acid, fumaric acid, crotonic acid, vinylacetic acid, and vinyllactic acid. Examples of suitable ethylenically unsaturated sulfonic acids include vinyl-sulfonic acid, styrenesulfonic acid, acrylamidomethylpropanesulfonic acid, sulfopropyl acrylate, and sulfopropyl methacrylate. Preferred are acrylic acid and methacrylic acid and a mixture thereof; acrylic acid is particularly preferred.

The acid groups of the protective colloid may be neutralized partly or completely with suitable bases. It is preferred to use aqueous sodium or potassium hydroxide solution or ammonia as neutralizing agent.

The protective colloid is formed to an extent of at least 10 wt. %, preferably 30 to 90 wt. %, of (meth)acrylate ester monomers. The (meth)acrylate ester monomers are preferably selected from the group consisting of C1 to C20 alkyl acrylates and C1 to C20-alkyl methacrylates, more particularly of C1 to C10 alkyl acrylates and C1 to C10 alkyl methacrylates. Suitable monomers are, for example, (meth)acrylic acid alkyl esters having a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters.

The protective colloid B may optionally be synthesized from further monomers. The further monomers can be used in amounts of, for example, 0 to 20 wt. % or of 0.1 to 15 wt. %. The further monomers may be selected from the group consisting of vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, and mixtures of these monomers. Vinyl esters of carboxylic acids having 1 to 20 C atoms are, for example, vinyl laurate, vinyl stearate, vinyl propionate, Versatic acid vinyl esters, and vinyl acetate. Vinylaromatic compounds contemplated include vinyltoluene, alpha- and para-methylstyrene, alpha-butylstyrene, 4-n-butylstyrene, 4-n-decylstyrene, and—preferably—styrene. Examples of nitriles are acrylonitrile and methacrylonitrile. The vinyl halides are ethylenically unsaturated compounds substituted by chlorine, fluorine, or bromine; preferably vinyl chloride and vinylidene chloride. Examples of vinyl ethers include vinyl methyl ether and vinyl isobutyl ether. Preferred vinyl ethers are those of alcohols comprising 1 to 4 C atoms. Hydrocarbons having 4 to 8 C atoms and two olefinic double bonds include butadiene, isoprene, and chloroprene.

In one particular embodiment the protective colloid B contains crosslinkable groups. The crosslinkable groups are obtained preferably by copolymerization with monomers which comprise crosslinkable groups. Preferred crosslinkable groups are, for example, the keto group or at least one further (second) radically polymerizable ethylenically unsaturated double bond. Preferred protective colloids are therefore those obtained by copolymerization with monomers which have at least one keto group or which contain at least two radically polymerizable ethylenically unsaturated double bonds. An example of a suitable keto monomer is acetoacetoxyethyl methacrylate (AAEMA). A suitable monomer having two radically polymerizable ethylenically unsaturated double bonds is, for example, allyl methacrylate (AMA). The monomers having crosslinkable groups are used preferably in an amount of 0 to 15 wt. %, more particularly of 0.5 to 10 wt. %.

In one embodiment the protective colloid B is formed from

(i) at least 10 wt. % of acid monomers selected from the group consisting of acrylic acid, methacrylic acid, and a mixture thereof;

(ii) at least 50 wt.% of monomers selected from the group consisting of C1 to C10 alkyl acrylates, C1 to C10 alkyl methacrylates, and a mixture thereof; and

(iii) 0 to 15 wt. % of monomers which have at least one keto group;

wherein the polymer A is preferably formed to an extent of 80 to 100 wt. % of C1-10 alkyl (meth)acrylates.

In one embodiment of the invention the polymerization of the protective colloid is carried out using at least one chain transfer agent (CTA). By this means it is possible to reduce the molar mass of the emulsion polymer, by a chain termination reaction. The CTAs here become attached to the polymer, generally to the chain end. The amount of the CTAs is more particularly 0.05 to 4 parts by weight, more preferably 0.05 to 0.8 part by weight, and very preferably 0.1 to 0.6 part by weight, based on 100 parts by weight of the monomers to be polymerized. Examples of suitable CTAs are compounds with a thiol group such as tert-butyl mercaptan, thioglycolic acid ethylacrylic esters, mercaptoethanol, mercaptopropyltrimethoxysilane, or tert-dodecyl mercaptan. The CTAs are generally compounds of low molecular mass, having a molar weight of less than 2000, more particularly less than 1000 g/mol.

The number-average molecular weight of the protective colloids is preferably above 1000 g/mol, more particularly above 2000 g/mol, and preferably up to 50000 g/mol or up to 20000 g/mol, as for example from 1000 to 50000 g/mol, from 1000 to 20000 g/mol, or from 2000 to 20000 g/mol.

In one embodiment of the invention the polymerization of the protective colloid takes place in the presence of seed latex. Seed latex is an aqueous dispersion of fine polymer particles having an average particle diameter of preferably 20 to 100 nm. Seed latex is used in an amount of preferably 0.05 to 5 wt. %, more preferably of 0.1 to 3 wt. %., based on the total monomer amount. A suitable latex is, for example, one based on polystyrene or based on polymethyl methacrylate. A preferred seed latex is polystyrene seed.

The weight ratio of the amount of protective colloid B to the amount of the monomers used to form the polymer A is preferably from 3 to 30 pphm (parts per hundred monomers) or 3 to 20 pphm, more preferably 5 to 15 or 5 to 13 pphm.

The monomers used for the polymerization of the polymer A are, to an extent of at least 80 wt. %, as for example from 80 to 100 wt. %, more preferably to an extent of at least 90 wt. % or 100 wt. %, (meth)acrylate ester monomers. The methacrylate ester monomers are preferably selected from C₁-C₂₀ alkyl (meth)acrylates, more particularly from C₁-C₁₀ alkyl(meth)acrylates. Especially preferred are methyl acrylate, methyl methacrylate, ethyl acrylate, n-butyl acrylate, n-butyl methacrylate, n-hexyl acrylate, octyl acrylate, 2-ethylhexyl acrylate, and 2-propylheptyl acrylate. Also suitable in particular are mixtures of the (meth)acrylic acid alkyl esters.

The polymer A may optionally be synthesized from further monomers. The further monomers can be used in amounts of, for example, 0 to 20 wt. % or of 0.1 to 10 wt. %. The further monomers may be selected from the group consisting of acid monomers, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, and mixtures of these monomers. Vinyl esters of carboxylic acids having 1 to 20 C atoms are, for example, vinyl laurate, vinyl stearate, vinyl propionate, Versatic acid vinyl esters, and vinyl acetate. Vinylaromatic compounds contemplated include vinyltoluene, a- and para-methylstyrene, alpha-butylstyrene, 4-n-butylstyrene, 4-n-decylstyrene, and—preferably—styrene. Examples of nitriles are acrylonitrile and methacrylonitrile. The vinyl halides are ethylenically unsaturated compounds substituted by chlorine, fluorine, or bromine; preferably vinyl chloride and vinylidene chloride. Examples of vinyl ethers include vinyl methyl ether and vinyl isobutyl ether. Preferred vinyl ethers are those of alcohols comprising 1 to 4 C atoms. Hydrocarbons having 4 to 8 C atoms and two olefinic double bonds include butadiene, isoprene, and chloroprene. Furthermore, the polymer A may additionally have been synthesized from allyl methacrylate (AMA).

As well as the stated monomers, the monomers for the polymerization of the polymer A may comprise further monomers, examples being monomers with carboxylic acid, sulfonic acid, or phosphonic acid groups. Carboxylic acid groups are preferred. Examples include acrylic acid, methacrylic acid, itaconic acid, maleic acid, and fumaric acid. Further monomers are also, for example, monomers comprising hydroxyl groups, more particularly C₁-C₁₀ hydroxyalkyl(meth)acrylates, and also (meth)acrylamide. As further monomers it is additionally possible to cite phenyloxyethyl glycol mono(meth)acrylate, glycidyl acrylate, glycidyl methacrylate, and amino (meth)acrylates such as 2-aminoethyl (meth)acrylate. Crosslinking monomers may also be cited as further monomers.

The monomers used for the polymerization of the polymer A preferably comprise less than 5 wt. % of, less than 1 wt. % of, or no monomers having acid groups.

The monomers for the polymerization of the polymer A are preferably selected such that the calculated glass transition temperature is situated in the range from −60° C. to 0° C., more particularly from −50° C. to −20° C. Through skilled variation in the nature and amount of the monomers it is possible for the skilled person to prepare aqueous polymer compositions in which the polymers have a glass transition temperature within the desired range. A guideline is possible by means of the Fox equation. According to Fox (T. G. Fox, Bull. Am. Phys. Soc. 1956 [Ser. II] 1, page 123 and in accordance with Ullmann's Encyclopädie der technischen Chemie, volume 19, page 18, 4th edition, Verlag Chemie, Weinheim, 1980), the glass transition temperature of copolymers is calculated in good approximation by:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n, and T_{g}¹, T_{g}², T_{g}ⁿ are the glass transition temperatures of the polymers synthesized in each case only from one of the monomers 1, 2, . . . n, in degrees Kelvin. The T_{g} values for the homopolymers of the majority of monomers are known and are listed for example in Ullmann's Encyclopedia of Industrial Chemistry, volume A21, page 169, 5th edition, VCH Weinheim, 1992; other sources for glass transition temperatures of homopolymers include, for example, J. Brandrup, E.H. Immergut, Polymer Handbook, 1^{st} edition, J. Wiley, New York 1966, 2^{nd} edition, J. Wiley, New York 1975, and 3^{rd} edition, J. Wiley, New York 1989.

The actual glass transition temperature of the protective colloid B is preferably in the range from −20° C. to +80° C. The actual glass transition temperature can be determined by means of differential scanning calorimetry (ASTM D 3418-08, midpoint temperature).

The polymer dispersion of the invention is prepared by emulsion polymerization. In the course of the emulsion polymerization, ethylenically unsaturated compounds (monomers) are polymerized in water, usually using ionic and/or non-ionic emulsifiers and/or protective colloids, and/or stabilizers, as interface-active compounds for stabilizing the monomer droplets and the polymer particles subsequently formed from the monomers. A feature of the preparation process of the invention, however, is that it is possible very largely or entirely to do without emulsifers. The protective colloid B is used to stabilize the polymer formed in the polymerization.

Acid groups in the protective colloid are neutralized preferably before or during the polymerization of the polymer A. After all of the monomers have been fed in, the polymerization vessel preferably contains the amount of neutralizing agent needed to neutralize at least 10%, preferably 30% to 100% or 30% to 90% acid equivalents.

In accordance with the invention, the addition of protective colloid and monomers takes place in a characteristic ramp regime. In the preparation process of the invention at least 80 wt. %, preferably 80 to 100 wt. %, of the total amount of the protective colloid is run in during the emulsion polymerization in a feed process, and the addition of monomer as well takes place in the feed process, with the feed rate rising over time; i.e., the final rate of monomer feed is higher than the initial rate. The feed rate preferably rises continuously or incrementally in a plurality of steps, as for example in at least three or at least five steps. The feed rate for the protective colloid as well preferably increases continuously or in a plurality of steps incrementally, as for example in at least three or at least five steps. At the beginning of the polymerization, therefore, there is only very little protective colloid in the initial charge, or preferably none at all. The addition of protective colloid preferably begins only after the polymerization has been commenced and at least 1 wt. %, at least 2 wt. %, or at least 5 wt. % of the total monomer amount has already been added to the polymerization vessel. The addition of protective colloid is preferably continuous or incremental and in parallel with the continuous or incremental addition of the rest of the monomers.

The polymerization takes place preferably such that, during the emulsion polymerization, not more than 10 wt. % of the monomers used to form the polymer A are added at the initial rate of the monomer feed or at a feed rate which is lower than the final rate of the monomer feed.

The emulsion polymerization can be initiated using water-soluble initiators. Water-soluble initiators are, for example, ammonium salts and alkali metal salts of peroxodisulfuric acid, such as sodium peroxodisulfate, hydrogen peroxide or organic peroxides, e.g. tert-butyl hydroperoxide. Also suitable as initiators are those known as reduction-oxidation (redox) initiator systems. The redox initiator systems consist of at least one, usually inorganic, reducing agent and one organic or inorganic oxidizing agent. The oxidizing component comprises, for example, the initiators already stated above for the emulsion polymerization. The reducing component is, for example, alkali metal salts of sulfurous acid, such as, for example, sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used along with soluble metal compounds whose metallic component is able to exist in a plurality of valence states. Customary redox initiator systems are, for example, ascorbic acid/iron(II) sulfate/sodium peroxodisulfate, tert-butyl hydroperoxide/sodium disulfite, tert-butyl hydroperoxide/Na-hydroxymethanesulfinic acid. The individual components—the reducing component, for example—may also be mixtures, an example being a mixture of the sodium salt of hydroxymethanesulfinic acid with sodium disulfite.

The stated initiators are used usually in the form of aqueous solutions, with the lower concentration being determined by the amount of water that is acceptable in the dispersion, and the upper concentration by the solubility of the respective compound in water. Generally speaking, the concentration of the initiators is 0.1 to 30 wt. %, preferably 0.5 to 20 wt. %, more preferably 1.0 to 10 wt. %, based on the monomers to be polymerized. It is also possible for two or more different initiators to be used in the emulsion polymerization.

In the polymerization it is possible to use the chain transfer agents (CTAS) specified above for the preparation of the protective colloid.

The emulsion polymerization takes place in general at 30 to 130° C., preferably at 50 to 100° C. The temperature is preferably raised during the polymerization—for example, from a starting temperature in the range from 50 to 85° C. to a final temperature in the range from greater than 85 to 100° C. The polymerization medium may consist either of water alone or of mixtures of water and water-miscible liquids such as methanol. It is preferred to use just water. A polymer seed may be included in the initial polymerization charge, for more effective establishment of the particle size.

The manner in which the initiator is added to the polymerization vessel in the course of the radical aqueous emulsion polymerization is known to a person of ordinary skill in the art. It may either be included in its entirety in the initial charge to the polymerization vessel, or else inserted continuously or in stages, at the rate at which it is consumed, in the course of the radical aqueous emulsion polymerization. In each specific case this will depend on the chemical nature of the initiator system and on the polymerization temperature. It is preferred to include part in the initial charge and to feed in the remainder to the polymerization zone at the rate of its consumption. For the purpose of removing the residual monomers, initiator is usually also added after the end of the emulsion polymerization proper, i.e., after a monomer conversion of at least 95%. For the feed process, the individual components may be added to the reactor from the top, in the side, or from below, through the reactor base.

The emulsion polymerization of the invention produces aqueous polymer dispersions generally having solids contents of greater than 60 wt %, as for example at least 61 wt %, at least 63 wt %, or at least 65 wt %. A bimodal or polymodal particle size may be set, in order to give an even better rheological behavior, more particularly a lower viscosity.

The polymer thus prepared is used preferably in the form of its aqueous dispersion. The size distribution of the dispersion particles may be monomodal, bimodal, or multimodal. In the case of monomodal particle size distribution, the average particle size of the polymer particles dispersed in the aqueous dispersion is preferably less than 400 nm, more particularly less than 200 nm. By average particle size here is meant the d₅₀ of the particle size distribution, i.e., 50 wt % of the total masses of all the particles have a smaller particle diameter than the d₅₀ figure. The particle size distribution can be determined in a known way using the analytical ultracentrifuge (W. Mächtle, Makromolekulare Chemie 185 (1984), pages 1025-1039). In the case of bimodal or multimodal particle size distribution, the particle size may be up to 1000 nm. The pH of the polymer dispersion is preferably set at a level of greater than 5, more particularly at a level of between 5.5 and 8.

In accordance with the invention, the polymer dispersions of the invention are used in aqueous adhesive formulations, for the purpose, for example, of producing pressure-sensitive adhesives or producing laminates—i.e., in aqueous laminating adhesive formulations for bonding substrates of large surface area, such as for producing composite films, for example.

Also provided by the invention are the aqueous polymer dispersions prepared in accordance with the invention.

The invention also provides the use of the aqueous polymer dispersions, prepared in accordance with the invention, for producing adhesives, more particularly for producing pressure-sensitive adhesives or laminating adhesives, as for example for producing composite films or for protective-film lamination.

The present invention therefore also relates to a process for producing adhesives articles, examples being labels or composite films, by using an aqueous adhesive formulation which comprises at least one polymer dispersion of the invention, and coating a substrate with the aqueous adhesive formulation. In this case, the aqueous polymer dispersions may be used as they are or after formulation with customary auxiliaries. Examples of customary auxiliaries include wetting agents, thickeners, other protective colloids, light stabilizers, biocides, defoamers, etc. The adhesive formulations of the invention may have been admixed with plasticizing resins (tackifiers) or other plasticizers. In the case of the process for producing composite films, at least two films are bonded to one another using the aqueous polymer dispersion.

In the context of application as an adhesive, the polymer dispersion of the invention or a preparation formulated accordingly is applied by knife coating, spread coating, etc., for example, in a layer thickness of 0.1 to 20 g/m², more preferably 1 to 7 g/m², to a substrate to which bonding is to take place. Use may be made of customary coating methods, examples being roll coating, counter-rotating roll coating, gravure roll coating, counter-rotating gravure roll coating, brush coating, rod coating, spray coating, air-brush coating, meniscus coating, curtain coating, or dip coating. After a short time for evaporation of the dispersion water (preferably after 1 to 60 seconds), the coated substrate can then be further-processed.

The polymer dispersion of the invention is preferably employed as a one-component composition, i.e., without additional crosslinking agents, more particularly without isocyanate crosslinkers. However, the polymer dispersion of the invention can also be used a two-component adhesive, in which case a crosslinking component is added, such as a water-emulsifiable isocyanate, for example.

In one embodiment, the protective colloid comprises at least one crosslinkable group, keto groups being an example. The adhesive formulation in that case preferably comprises at least one compound that is reactive with keto groups, examples being diamines, preferably propylenediamine, diethylenetriamine, dipropylenetriamine, N-(2-aminoethyl)aminopropylamine, N,N-bis(3-aminopropyl)methylamine, N,N′-bis(3-aminopropyl)ethylenediamine, preferably in an amount of a few weight percent (e.g., 235 pL propylenediamine per 100 mL dispersion). Other reactive groups as well (comprehensive description: J. W. Taylor, M. A. Winnik, JCT Research, Vol. 1. No. 3, July 2004) are suitable as crosslinkers.

Suitable substrates are, for example, paper or polymeric films. The films may have been metallized or printed on the adhesive-coated side. Examples of suitable substrates include polymeric films, more particularly those of polyethylene (PE), oriented polypropylene (OPP), unoriented polypropylene (CPP), polyamide (PA), polyethylene terephthalate (PET), polyacetate, cellophane, polymeric films coated (vapor-coated) with metal, aluminum for example (metallized films for short), or metal foils, examples being those of aluminum. The stated films and foils may be bonded to one another or to a film/foil of another type—e.g., polymeric films to metal foils—and different polymeric films may be bonded to one another, etc. The stated foils and films may also have been printed, for example, with printing inks.

One embodiment of the invention is a composite film produced using one of the aqueous polymer dispersions of the invention described above, where the material of a first film is selected from OPP, CPP, PE, PET, and PA, and where the material of a second film is selected from OPP, CPP, PE, PET, PA, and metal foil. In one embodiment of the invention the first film and/or the second film is metallized or printed on the respective side which is coated with the polymer dispersion of the invention. The thickness of the substrate films may be for example from 5 to 100 μm, preferably from 5 to 40 μm.

Surface treatment of the film substrates prior to coating with a polymer dispersion of the invention is not absolutely necessary. Better results can be obtained, however, if the surface of the film substrates is modified prior to coating. In this case it is possible to employ customary surface treatments, an example being corona treatment, for the purpose of boosting the adhesive effect. The corona treatment or other surface treatments are carried out to the degree necessary for sufficient wettability with the coating composition. Customarily a corona treatment of approximately 10 watts per square meter per minute is sufficient for this purpose. Alternatively or additionally it is also possible optionally to use primers or intercoats between film substrate and adhesive coating. Moreover, the composite films may have further, additional functional layers, examples being barrier layers, print layers, ink or varnish layers, or protective layers. These functional layers may be located externally, i.e., on the side of the film substrate opposite from the adhesive-coated side, or internally, between film substrate and adhesive layer.

Particular advantages of the preparation process of the invention and of the products of the invention are especially:
it is possible to have a virtually emulsifier-free procedure (small amounts of emulsifier when using an emulsifier-stabilized polymer seed do no harm)
comparatively high solids contents by comparison with conventional, commercially available adhesive dispersions, and consequently reduced energy expenditure for drying
comparatively low viscosity by comparison with conventional polymer dispersions of similarly high solids content.

### EXAMPLES

Ingredients and abbreviations used:

| | |
|---|---|
| nBA | n-butyl acrylate |
| AA | acrylic acid |
| AAEMA | acetoacetoxyethyl methacrylate |
| AMA | allyl methacrylate |
| HEA | hydroxyethyl acrylate |
| EA | ethyl acrylate |
| EHTG | 2-ethyhexyl thioglycolate |
| SC | solids content |

The general ramp regime is as follows:

Monomer feed: 1%, 2%, 3% each in 3 min,

meter the rest in 2h 40 min.

Feed of protective colloid: start 20 min after the start of monomer feed:

meter in 1.3%, 6.4%, 11.6%, 13.6% each in 23 min,

18.1% in 22 min,

22.6% in 21 min, and

26.4% in 25 min.

At the same time the temperature is raised over 3h from 75 to 95° C.

Using this regime it is possible as well as acid groups to introduce other functionalities as well into the protective colloids, examples being keto groups via AAEMA as monomer, and so postcrosslinking is possible after film formation. This can be verified by means of DMA measurements.

An overview of polymerization results is compiled in table 1.

TABLE 1
Polymerization results, quantities in parts by weight

| Example | Protective colloid B | Polymer A | SC [%] | Rheology |
|---|---|---|---|---|
| B1 | 12.5 [65 nBA/35 AA], | 100 EA, | 63.6 | fluid |
| | SC = 30.6% | 0.3 EHTG | | |
| B2 | 12.5 [60 nBA/35 AA/ | 100 EA, | 65.4 | fluid |
| | 5 AAEMA], | 0.3 EHTG | | |
| | SC = 43.2% | | | |
| B3 | 12.5 [65 nBA/35 AA], | 80 nBA/ | 64.3 | fluid |
| | SC = 30.6% | 10 MA/ | | |
| | | 10 MMA | | |
| B4 | 12.5 [60 nBA/35 AA/ | 80 nBA/ | 64.0 | fluid |
| | 5 AAEMA], SC = 43.2% | 10 MA/ | | |
| | | 10 MMA | | |
| B5 | 12.5 [65 nBA/35 AA], | 100 EA, | 60 | pasty, |
| | SC = 30.0% | 0.3 EHTG | | not fluid |
| B6 | 12.5 [65 nBA/35 AA], | 100 EA, | 57 | pasty, |
| | SC = 27.1% | 0.3 EHTG | | not fluid |
| B7 | 10.0 [60 nBA/35 AA/ | 100 EA, | 50 | pasty, |
| | 5 AMA], SC = 35.0% | 0.3 EHTG | | not fluid |
| B8 | 10.0 [100 HEA], | 100 EA, | 50 | pasty, |
| | SC = 24.5% | 0.3 EHTG | | not fluid |

B1-B4: inventive, prepared in ramp regime
B5-B8: comparative, protective colloid included entirely in the initial charge

The polymer dispersions prepared in accordance with the invention feature a low viscosity with a fluid consistency.

1. A process for preparing an aqueous polymer dispersion,
where wherein the polymer dispersion has a solids content of greater than 60 wt. %,
the process comprising:
preparing a polymer A in dispersion in water is prepared in an aqueous medium by radical emulsion polymerization in the presence of a polymeric protective colloid B to obtain the aqueous polymer dispersion,
wherein the polymer A is formed to an extent of at least 80 wt. % of (meth)acrylate ester monomers,
the polymeric protective colloid B is formed from acid monomers, where to an extent of at least 10 wt. % from (meth)acrylate ester monomers and the total of (meth)acrylate ester monomers and acid monomers in the protective colloid is at least 80 wt. %,
where at least 80 wt. %, of the total amount of the protective colloid is run in during the emulsion polymerization in a feed process,
the emulsion polymerization takes place in the monomer feed process with a changing feed rate, and
an the initial rate of the monomer feed is lower than the final feed rate.

2. The process according to claim 1, wherein a total of less than 0.5 wt. % of emulsifier, based on solids content of the polymer dispersion, is employed, or
wherein the polymerization takes place in emulsifier-free form.

3. The process according to claim 1, wherein the polymeric protective colloid B is formed from monomers which have acid groups and from monomers which do not have acid groups, wherein a weight ratio of monomers having acid groups to monomers without acid groups is from 10:90 to 50:50.

4. The process according to claim 1, wherein the polymeric protective colloid B is formed to an extent of 10 to 50 wt. % of acid monomers and 30 to 90 wt. % of (meth)acrylate ester monomers.

5. The process according to claim 1, wherein the acid monomers are selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, and mixtures of these monomers.

6. The process according to claim 1, wherein the (meth)acrylate ester monomers are selected from the group consisting of C1 to C20 alkyl acrylates and C1 to C20 alkyl methacrylates.

7. The process according to claim 1, wherein the polymer A and/or the protective colloid B have been synthesized from further monomers, selected from the group consisting of acid monomers, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, and mixtures of these monomers.

8. The process according to claim 1, wherein the protective colloid B has crosslinkable groups.

9. The process according to claim 1, wherein the protective colloid B is formed from
(i) at least 10 wt. % of acid monomers selected from the group consisting of acrylic acid, methacrylic acid, and a mixture thereof;
(ii) at least 50 wt. % of monomers selected from the group consisting of C1 to C10 alkyl acrylates, C1 to C10 alkyl methacrylates, and a mixture thereof; and
(iii) 0 to 15 wt. % of monomers which have at lest one a keto group;
and/or the polymer A is formed to an extent of 80 to 100 wt. % of C1-10 alkyl (meth)-acrylates.

10. The process according to claim 1, wherein the weight ratio of the protective colloid B to the amount of monomers used to form the polymer A is 3 to 30 parts by weight of protective colloid per 100 parts by weight of monomers.

11. The process according to claim 1, wherein the monomers used to form the polymer A comprise less than 5 wt. % or no monomers having acid groups.

12. The process according to claim 1, wherein during the emulsion polymerization not more than 10 wt. % of the monomers used to form the polymer A are added at the initial rate of the monomer feed or at a feed rate which is lower than the final rate of the monomer feed.

13. An aqueous polymer dispersion prepared by the process according to claim 1.

14. The aqueous polymer dispersion according to claim 13, wherein the aqueous polymer dispersion is suitable for producing adhesives, for producing composite films, or for protective-film lamination.
